(19) United States
(12) Patent Application Publication
(10) Pub. No.: US 2005/0015611 A1
(43) Pub. Date: Jan. 20, 2005

(54) Trusted peripheral mechanism

(76) Inventor: David I. Poisner, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/609,508

(22) Filed: Jun. 30, 2003

(51) Int. Cl. H04L 9/00

(52) U.S. Cl. 713/200; 713/189

(57) ABSTRACT

According to one embodiment, computer system is disclosed. The computer system includes a central processing unit (CPU), and a chipset coupled to the CPU including protected registers and a host controller. The computer system also includes a bus coupled to the host controller and a peripheral device coupled the bus. Trusted software accesses the protected registers to transmit encrypted data between the host controller and the peripheral device upon startup of the computer system to verify that the peripheral device is trustworthy.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to computer systems that may operate in a trusted or secured environment.

### BACKGROUND

The increasing number of financial and personal transactions being performed on local or remote microcomputers has given impetus for the establishment of “trusted” or “secured” microprocessor environments. The problem these environments try to solve is that of loss of privacy, or data being corrupted or abused. Users do not want their private data made public. They also do not want their data altered or used in inappropriate transactions. Examples of these include unintentional release of medical records or electronic theft of funds from an on-line bank or other depository. Similarly, content providers seek to protect digital content (for example, music, other audio, video, or other types of data in general) from being copied without authorization.

However, a Universal Serial Bus (USB), adhering to a 2.0 standard developed by Compaq, IBM, DEC, Intel, Microsoft, NEC, and Northern Telecom, poses a significant problem to trusted input/output (I/O). A USB is a plug-and-play interface between a computer system and an add-on device (e.g., a keyboard). The computer system typically includes a software stack that is associated with the USB device.

Malicious code in a USB stack could potentially be used to modify data transmitted to/from the USB peripheral, or re-route the data to an entirely different device. One method used to thwart malicious USB software is to encrypt data transmitted to or received from the USB peripheral. However, the problem with the encryption method is that the USB stack cannot be trusted with transmitting encryption keys to the peripheral.

One mechanism includes bypassing the USB stack by transmitting encryption keys directly to a keyboard peripheral. In such a mechanism, a user is prompted to type keystrokes on the keyboard in order to enter an encryption key. Such a mechanism is inefficient since it would require the user to type up to sixty-three keystrokes each time the computer system is started up.

Alternatively, the keyboard would require non-volatile memory storage to avoid the user having to input keystrokes each time the keyboard is powered. This would result in an increase in cost for keyboard manufacture. In addition, such a mechanism is not applicable for use in non-keyboard peripherals, such as a mouse, unless an encryption dongle is added inline between the computer system and the peripheral. This also leads to an increase in costs.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 is a block diagram illustrating one embodiment of a central processing unit (CPU);

FIG. 3 is a block diagram illustrating one embodiment of a memory; and

FIG. 4 is a flow diagram of one embodiment of transmitting an encryption key to a peripheral device.

### DETAILED DESCRIPTION

A mechanism to guarantee trusted USB input/output (I/O) at a computer system is described. According to one embodiment, a trusted port in the computer system is implemented to transmit encryption keys to a USB peripheral without using a USB stack.

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

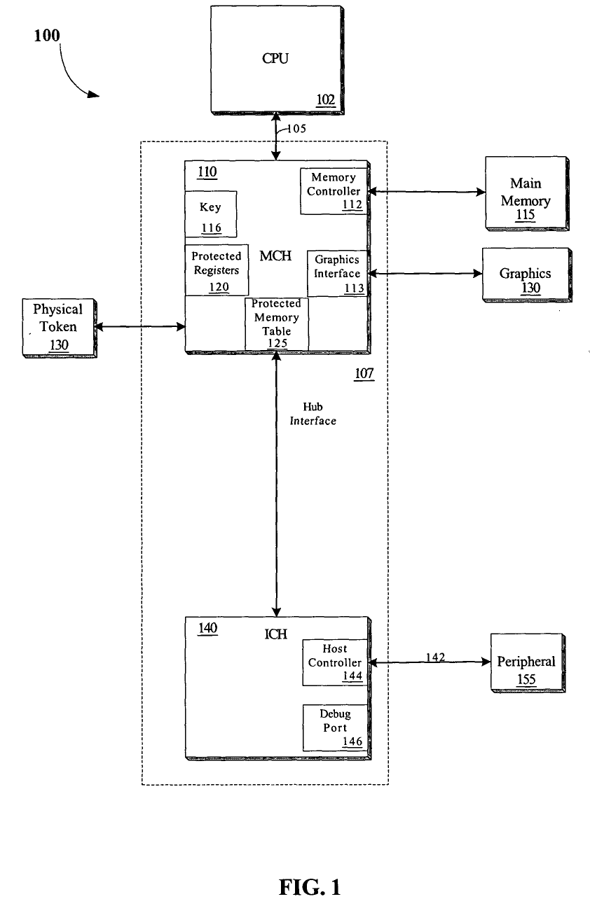

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

FIG. 2 is a block diagram illustrating one embodiment of CPU 102. In one embodiment, CPU 102 includes cache memory (cache) 220, embedded key 230, and page table (PT) registers 240. All or part of cache 220 may include, or be convertible to, private memory (PM) 225. According to one embodiment, private memory 225 is a memory with sufficient protections to prevent access to it by any unauthorized device (e.g., any device other than the associated CPU 102) while activated as a private memory.

In the illustrated embodiment, cache 220 may have various features to permit its selective isolation as a private memory. In another embodiment not shown, private memory 225 may be external to and separate from cache memory 550, but still associated with CPU 102. Key 230 may be an embedded key to be used for encryption, decryption, and/or validation of various blocks of data and/or code. PT registers 240 may be a table in the form of registers to identify memory pages that are to be accessible only by protected code, and which memory pages are not to be protected.

Referring back to FIG. 1, a chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

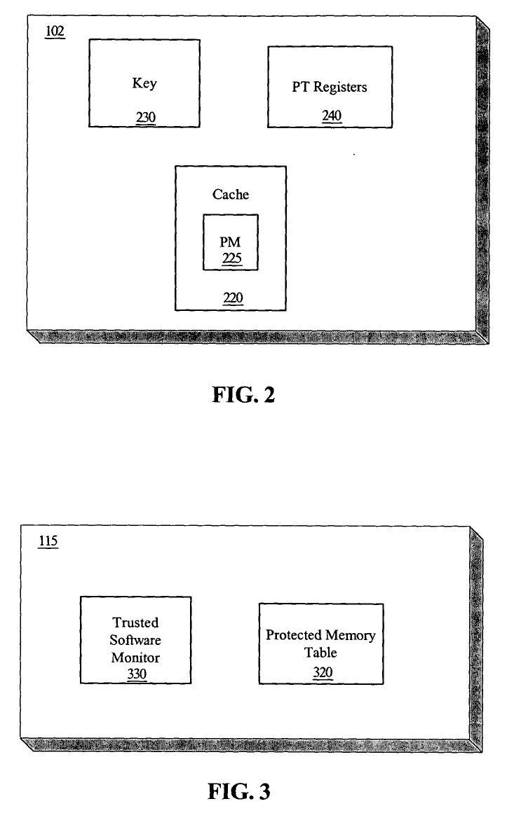

FIG. 3 is a block diagram illustrating one embodiment of memory 115. Referring to FIG. 3, memory 115 may include protected memory table 320 and trusted software (s/w) monitor 330. In some embodiments, protected memory table 320 is a table to define which memory blocks (where a memory block is a range of contiguously addressable memory locations) in memory 115 are to be inaccessible to direct memory access (DMA) transfers.

Since all accesses to memory 115 go through MCH 110, MCH 110 may check protected memory table 320 before permitting any DMA transfer to take place. In a particular embodiment, MCH 110 may use caching techniques to reduce the number of necessary accesses to protected memory table 320.

In one embodiment, protected memory table 320 is implemented as a table of bits, with each bit corresponding to a particular memory block in memory 115 (e.g., each bit may correspond to a single page, with a logic ‘1’ indicating the page is protected from DMA transfers and a logic ‘0’ indicating the page is not so protected). In a particular operation, the memory blocks protected from DMA transfers by protected memory table 320 may be the same memory blocks restricted to protected processing by PT registers 240 in CPU 102.

In one embodiment, trusted s/w monitor 330 monitors and controls a protected operating environment once the protected operating environment has been established. In a particular embodiment, trusted s/w monitor 330 is located only in memory blocks that are protected from data transfers (e.g., DMA transfers) by protected memory table 320, thus assuring that trusted s/w monitor 330 cannot be compromised by data transfers from unprotected and/or unauthorized devices. The protected memory table 320 may also protect itself from alteration by data transactions by protecting the memory blocks including protected memory table 320.

Referring back to FIG. 1, MCH 110 may also include a graphics interface 113 coupled to a graphics accelerator 130. In one embodiment, graphics interface 113 is coupled to graphics accelerator 130 via an accelerated graphics port (AGP) that operates according to an AGP Specification Revision 2.0 interface developed by Intel Corporation of Santa Clara, Calif.

According to one embodiment, MCH 110 includes key 116 to be used in various encryption, decryption and/or validation processes, protected registers 120 and protected memory table 125. In one embodiment, the protected memory table 125 is implemented in MCH 110 as protected memory table 125 and protected memory table 320 may be eliminated.

In another embodiment, the protected memory table 125 is implemented as protected memory table 320 in memory 115 as previously described and protected memory table 125 may be eliminated. The protected memory table may also be implemented in other ways not shown. Regardless of physical location, the purpose and basic operation of the protected memory table may be substantially as described.

In one embodiment, protected registers 120 are registers that are writable by commands that may only be initiated by trusted microcode in CPU 102. Protected microcode is microcode whose execution may be initiated by authorized instruction(s) and/or by hardware that is not controllable by unauthorized devices. In one embodiment, protected registers 120 hold data that identifies the locations of, and/or controls access to, protected memory table 320 and trusted s/w monitor 330.

In one embodiment, protected registers 120 include a register to enable or disable the use of protected memory table 320 so that the DMA protections may be activated before entering a protected operating environment and deactivated after leaving the protected operating environment. Protected registers 120 may also include a writable register identifying the location of protected memory table 320, so that the location does not have to be hardwired into MCH 110.

In one embodiment, protected registers 120 may include the temporary location of the trusted s/w monitor 330 before it is placed into protected locations of memory 115, so that it may be located for the transfer. In one embodiment, protected registers 120 may include an execution start address of trusted s/w monitor 330 after the transfer into memory 115, so that execution may be transferred to trusted s/w monitor 330 after initialization of the protected operating environment.

Physical token 130 may be a circuit to protect data related to creating and maintaining a protected operating environment. In a particular embodiment, physical token 130 includes a key (not shown), which may be an embedded key to be used for specific encryption, decryption and/or validation processes. Physical token 130 may also include storage space to be used to hold a digest value and other information to be used in the protected operating environment. In one embodiment the storage space in physical token 130 may include non-volatile memory (e.g., flash memory) to retain its contents in the event of power loss to the physical token.

Referring back to FIG. 1, MCH 110 is coupled to an input/output control hub (ICH) 140 via a hub interface. ICH 140 provides an interface to input/output (I/O) devices within computer system 100. ICH 140 may be coupled to a USB peripheral 155 via a host controller 144. Host controller 144 controls the interface between ICH 140 and peripheral 155. One of ordinary skill will appreciate that other packet bases busses may be implemented without departing from the true scope of the invention.

In one embodiment, host controller 144 supports the peripheral configuration process wherein peripheral 155 is assigned an address. Subsequently, host controller 144 monitors the bus for packets addressed to it and handles the transfer of data to peripheral 155. The data is packaged into packets at host controller 144 prior to being transmitted to peripheral 155. Incoming packets are verified at host controller 144 for validity. In one embodiment, peripheral device 155 is a keyboard. However, in other embodiments, peripheral device 155 may be implemented using a mouse, audio player, joystick, telephone, scanner, printer, etc.

Debug port 146 enables hardware and software designers to debug features in their product. In one embodiment, debug port 146 implements a register-based mechanism to cause host controller 144 to perform transactions. Thus, the software stack and memory 115 associated with peripheral 155 on USB may be bypassed.

According to a further embodiment, a similar bypass is implemented to transmit encryption keys to peripheral 155 upon computer system 100 startup to verify that the USB connection with peripheral 155 is trustworthy. In such an embodiment, host controller 144 also includes protected registers similar to registers 120 in MCH 110. Therefore, the trusted software accesses protected registers within host controller 144.

The software writes to registers 120 to indicate to host controller 144 which encrypted message to transmit to peripheral 155, and what data to receive back from peripheral 155. In another embodiment, peripheral 155 generates the encryption key and transmits the key to host controller 144. In another embodiment, the host controller 144 and peripheral 155 implement a Diffie-Hellman exchange to provide immunity from external snooping. In yet another embodiment, host controller 144 and peripheral 155 implement the Diffie-Hellman exchange, in addition to a verification state to check for a Man-In-The-Middle type attack.

Host controller 144 reads the key through the trusted port. In a further embodiment, I/O traffic is transferred using the standard USB software stack and USB host controller 144 mechanism once peripheral 155 is using the encryption keys. Consequently, normal USB transactions are controlled by data structures in memory 115, and host controller 144 reads these structures and performs the appropriate read/write operations.

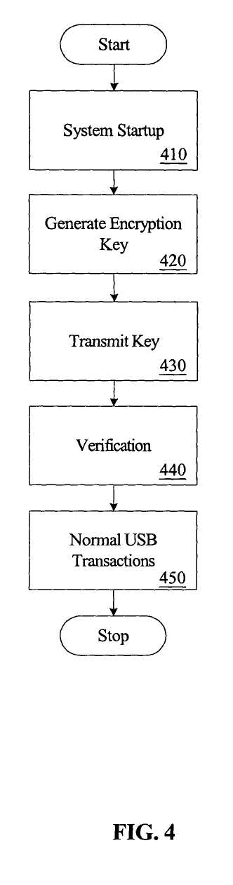

FIG. 4 is a flow diagram of one embodiment of transmitting an encryption key to a peripheral 155. At processing block 410, computer system 100 begins the startup (boot) process. At processing block 420, the trusted software generates the encryption key. However, as described above, the encryption key may be generated at peripheral device 155.

At processing block 430 the key is transmitted to peripheral device 155, bypassing the USB stack. As discussed above, the trusted software writes to registers 120 to initiate transmission of the encrypted key to peripheral 155, and what data to receive back from peripheral 155. In the embodiments in which the encryption key is generated at peripheral 155, the key is transmitted from peripheral 155 to host controller 144.

At processing block 440 a verification process occurs in which it is determined whether peripheral 155 is operating based upon the encryption key. According to one embodiment, the key is verified by putting a message on the display prompting the user to type a character on the keyboard. The character may be randomly chosen by the host software.

When the user types the key, the keyboard encrypts the key with the encryption key. The trusted OS software knows the encryption and the keystroke that was supposed to be typed, so OS software can decrypt the message and verify if it is correct. At processing block 450, host controller 144 is set up so that standard USB transactions can occur through the stack.

The description above implements trusted software and trusted registers to bypass the USB stack, thus thwarting malicious USB software that uses the standard USB stack to transmit imposter messages to the USB peripheral. Consequently, there is no requirement for a user to input encryption keys through a keyboard, nor a need for peripheral devices to implement non-volatile storage.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A computer system comprising:
a central processing unit (CPU);
a chipset, coupled to the CPU, including:
protected registers; and
a host controller;
a bus coupled to the host controller; and
a peripheral device coupled the bus, wherein trusted software accesses the protected registers to transmit encrypted data between the host controller and the peripheral device upon startup of the computer system to verify that the peripheral device is trustworthy.

2. The computer system of claim 1 wherein the encryption data is generated at the peripheral device and transmitted to the host controller.

3. The computer system of claim 1 wherein the encryption data is generated at the CPU and transmitted to the peripheral device.

4. The computer system of claim 1 wherein the trusted software writes to the protected register to indicate to the host controller the encrypted data to transmit and response data that is to be received.

5. The computer system of claim 1 wherein the chipset further comprises:
a protected memory table; and
a memory controller coupled to the memory device.

6. The computer system of claim 5 further comprising a memory device coupled to the memory controller.

7. The computer system of claim 6 wherein the data transmitted between the host controller and the peripheral device bypasses a stack at the memory device associated with the peripheral device.

8. The computer system of claim 7 wherein the memory device comprises:
a protected memory table; and
a trusted software monitor.

9. The computer system of claim 1 wherein the peripheral device is a keyboard.

10. The computer system of claim 1 wherein the peripheral device is a mouse.

11. The computer system of claim 1 wherein the peripheral device is a scanner.

12. The computer system of claim 1 wherein the bus is a Universal Serial Bus.

13. A chipset comprising:
protected registers; and
a host controller coupled to a peripheral device via a bus;
wherein trusted software accesses the protected registers to transmit encrypted data between the host controller and the peripheral device to verify that the peripheral device is trustworthy.

14. The chipset of claim 13 wherein the encryption data is generated at the peripheral device and transmitted to the host controller.

15. The chipset of claim 13 wherein the encryption data is received from a CPU coupled to the chipset and transmitted to the peripheral device.

16. The chipset of claim 13 wherein the trusted software writes to the protected register to indicate to the host controller the encrypted data to transmit and response data that is to be received.

17. The chipset of claim 13 wherein the chipset further comprises:
a protected memory table; and
a memory controller coupled to the memory device.

18. A method comprising:
generating an encryption key within a computer system using trusted software;
the trusted software writing to trusted registers within the computer system to initiate transmission of the encrypted key to a peripheral device; and
transmitting the encryption key to the peripheral device.

19. The method of claim 18 wherein the encryption key is transmitted to the peripheral device while bypassing a memory stack associated with the peripheral device.

20. The method of claim 18 further comprising verifying whether the peripheral device is operating based upon the encryption key.

21. A computer system comprising:
a central processing unit (CPU);
a chipset, coupled to the CPU, including:
protected registers; and
a host controller;
a memory device coupled to the chipset;
a bus coupled to the host controller; and
a peripheral device coupled the bus, wherein trusted software accesses the protected registers to transmit encrypted data between the host controller and the peripheral device upon startup of the computer system to verify that the peripheral device is trustworthy.

22. The computer system of claim 21 wherein the encryption data is generated at the peripheral device and transmitted to the host controller.

23. The computer system of claim 21 wherein the encryption data is generated at the CPU and transmitted to the peripheral device.

24. The computer system of claim 21 wherein the trusted software writes to the protected register to indicate to the host controller the encrypted data to transmit and response data that is to be received.

25. The computer system of claim 21 wherein the chipset further comprises:
a protected memory table; and
a memory controller coupled to the memory device.

26. The computer system of claim 21 wherein the data transmitted between the host controller and the peripheral device bypasses a stack at the memory device associated with the peripheral device.

27. The computer system of claim 21 wherein the memory device comprises:
a protected memory table; and
a trusted software monitor.

28. The computer system of claim 21 wherein the peripheral device is a keyboard.

29. The computer system of claim 21 wherein the peripheral device is a mouse.

30. The computer system of claim 21 wherein the peripheral device is a scanner.

31. The computer system of claim 21 wherein the bus is a Universal Serial Bus.
